(19) United States
(12) Patent Application Publication
(10) Pub. No.: US 2024/0428420 A1
(43) Pub. Date: Dec. 26, 2024

(54) System and Method for Adipose Tissue Segmentation on Magnetic Resonance Images

(71) Applicant: The Regents of the University of California, Oakland, CA (US)

(72) Inventors: Holden H. Wu, Los Angeles, CA (US); Sevgi Gokce Kafali-Tekat, Los Angeles, CA (US)

(21) Appl. No.: 18/704,325

(22) PCT Filed: Oct. 28, 2022
(86) PCT No.: PCT/US2022/048221

§ 371 Date: Apr. 24, 2024

Related U.S. Application Data
(60) Provisional application No. 63/273,006, filed on Oct. 28, 2021.

(51) Int. Cl. G06T 7/11; G06N 3/045; G06N 3/0464; G06N 3/08

(52) U.S. Cl. CPC G06T 7/11; G06N 3/045; G06N 3/0464; G06N 3/08; G06T 2207/10088; G06T 2207/20084; G06T 2207/30004

(57) ABSTRACT

A system for segmenting adipose tissues in magnetic resonance (MR) images includes a multi-channel input for receiving a set of combined multi-contrast MR images of a subject and an adipose tissue segmentation neural network coupled to the input and configured to generate at least one segmentation map for an adipose tissue. The system can further include a display coupled to the adipose tissue segmentation neural network and configured to display the at least one segmentation map for the adipose tissue. The adipose tissue segmentation neural network can be trained using a frequency-balancing boundary-emphasizing Dice Loss (FBDL) function.

### CROSS-REFERENCE TO RELATED APPLICATIONS

This application is based on, claims priority to, and incorporates herein by reference in its entirety U.S. Ser. No. 63/273,006 filed Oct. 28, 2021 and entitled “System and Method for Adipose Tissue Segmentation on Magnetic Resonance Images.”

### STATEMENT REGARDING FEDERALLY SPONSORED RESEARCH

This invention was made with government support under Grant No. DK124417.awarded by National Institutes of Health. The government has certain rights in the invention.

### BACKGROUND

Adipose tissue (AT) is a long-term energy depot organ that can release fatty acids to satisfy the body's energy needs. There are two main compartments to AT: visceral adipose tissue (VAT) and subcutaneous adipose tissue (SAT). Individuals with obesity have larger amounts of visceral adipose tissue (VAT) and subcutaneous adipose tissue (SAT) in their body, increasing the risk for cardiometabolic diseases. Magnetic resonance imaging (MRI) can be used to quantify body composition, for example, VAT and SAT, non-invasively and without ionizing radiation. VAT and SAT are potential biomarkers for detecting future risks for cardiometabolic diseases. For example, VAT plays a key role in metabolic activity via secretion of inflammatory markers. In addition, adipokines and proinflammatory cytokines secreted by VAT are contributing causes to the development of obesity-related tumors. The reference standard to analyze and quantify SAT and VAT relies on manual annotations of MRI, which can then be used to measure tissue volume and fat content (potential imaging biomarkers), for example, via proton-density fat fraction (PDFF). However, manual annotations require expert knowledge, may have intra-observer variability, and are time-consuming (especially for VAT), which may impede its use for large-scale and longitudinal studies.

Machine learning approaches have been proposed for automated segmentation of SAT and VAT. For example, deep learning-based methods have been proposed using architectures such as 2-dimensional (2D) U-Net, 2D Dense U-Net, 2.5-dimensional (2.5D) competitive Dense U-Net, 3-dimensional (3D) V-Net, and 3D Densely Connected (DC) Net. While these deep leaning studies may perform well for SAT segmentation (Dice scores of 0.97 to 0.99), the performance for VAT remains suboptimal (Dice scores of 0.43 to 0.89) due to the complex spatially varying and disconnected nature of VAT. Previous machine learning techniques for SAT/VAT segmentation have several key limitations such as (1) using only T₁-weighted (TIW) images or using only fat and water images, but not fully considering the multi-contrast information from MRI and the 3D anatomical context, and/or (2) using only 2D slices or cropped 3D image patches which do not capture the 3D anatomical context and global associations across the full imaging volume. Fully considering the multi-contrast information from MRI and the across-slice 3D anatomical context is critical for addressing the complex spatially varying structure and disconnected nature of VAT. An additional challenge is the imbalance between the number and distribution of pixels representing SAT/VAT.

Therefore, there is a need for systems and methods for rapid and accurate quantification of components of body composition such as, for example, VAT and SAT, which overcome the challenges and limitations discussed above.

### SUMMARY

In accordance with an embodiment, a system for segmenting adipose tissues in magnetic resonance (MR) images includes a multi-channel input for receiving a set of combined multi-contrast MR images of a subject, an adipose tissue segmentation neural network coupled to the input and configured to generate at least one segmentation map for an adipose tissue, and a display coupled to the adipose tissue segmentation neural network and configured to display the at least one segmentation map for the adipose tissue.

In accordance with another embodiment, a method for segmenting adipose tissues in magnetic resonance (MR) images includes receiving a set of combined multi-contrast MR images of a subject and providing the set of combined multi-contrast MR images to an adipose tissue segmentation neural network. The method further includes generating at least one segmentation map for an adipose tissue using the adipose tissue segmentation neural network and displaying the at least one segmentation map on a display.

### BRIEF DESCRIPTION OF THE DRAWINGS

The present invention will hereafter be described with reference to the accompanying drawings, wherein like reference numerals denote like elements.

FIG. 1 is a schematic diagram of an example magnetic resonance imaging (MRI) system in accordance with an embodiment;

FIG. 2 is a block diagram of a system for segmenting adipose tissues in magnetic resonance (MR) images in accordance with an embodiment;

FIG. 3 illustrates a method for segmenting adipose tissues in magnetic resonance (MR) images in accordance with an embodiment;

FIG. 4A illustrates an example three-dimensional (3D) neural network for segmentation of adipose tissue in accordance with an embodiment;

FIG. 4B illustrates example densely connected convolutional blocks incorporated in the 3D neural network of FIG. 4A in accordance with an embodiment;

FIG. 4C illustrates an example attention mechanism incorporated in the 3D neural network of FIG. 4A in accordance with an embodiment;

FIG. 5 illustrates an example 2.5-dimensional (2.5D) neural network for segmentation of adipose tissue in accordance with an embodiment; and

FIG. 6 is a block diagram of an example computer system in accordance with an embodiment.

### DETAILED DESCRIPTION

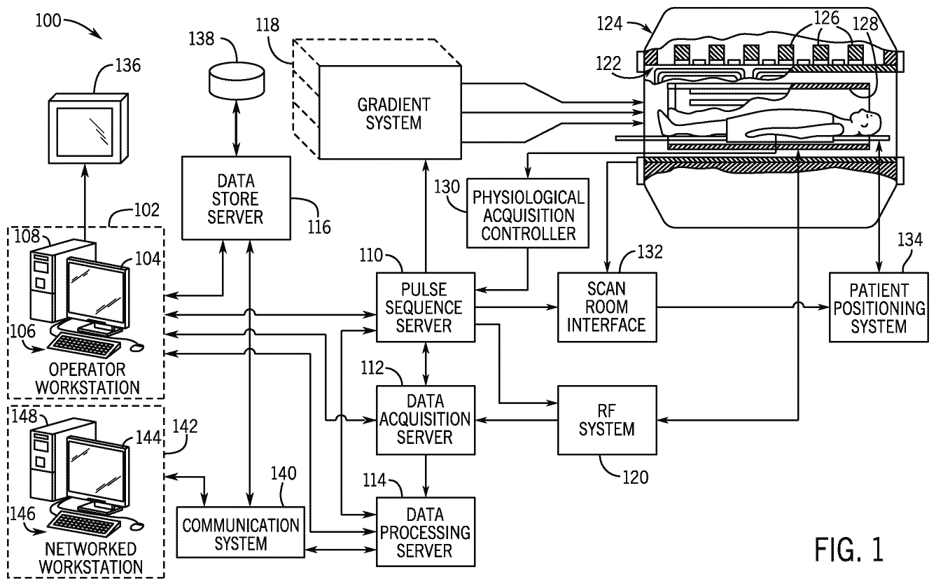

FIG. 1 shows an example of an MRI system 100 that may be used to perform the methods described herein. MRI system 100 includes an operator workstation 102, which may include a display 104, one or more input devices 106 (e.g., a keyboard, a mouse), and a processor 108. The processor 108 may include a commercially available programmable machine running a commercially available operating system. The operator workstation 102 provides an operator interface that facilitates entering scan parameters into the MRI system 100. The operator workstation 102 may be coupled to different servers, including, for example, a pulse sequence server 110, a data acquisition server 112, a data processing server 114, and a data store server 116. The operator workstation 102 and the servers 110, 112, 114, and 116 may be connected via a communication system 140, which may include wired or wireless network connections.

The pulse sequence server 110 functions in response to instructions provided by the operator workstation 102 to operate a gradient system 118 and a radiofrequency (“RF”) system 120. Gradient waveforms for performing a prescribed scan are produced and applied to the gradient system 118, which then excites gradient coils in an assembly 122 to produce the magnetic field gradients Gₓ, G_{y}, and G_{z} that are used for spatially encoding magnetic resonance signals. The gradient coil assembly 122 forms part of a magnet assembly 124 that includes a polarizing magnet 126 and a whole-body RF coil 128.

RF waveforms are applied by the RF system 120 to the RF coil 128, or a separate local coil to perform the prescribed magnetic resonance pulse sequence. Responsive magnetic resonance signals detected by the RF coil 128, or a separate local coil, are received by the RF system 120. The responsive magnetic resonance signals may be amplified, demodulated, filtered, and digitized under direction of commands produced by the pulse sequence server 110. The RF system 120 includes an RF transmitter for producing a wide variety of RF pulses used in MRI pulse sequences. The RF transmitter is responsive to the prescribed scan and direction from the pulse sequence server 110 to produce RF pulses of the desired frequency, phase, and pulse amplitude waveform. The generated RF pulses may be applied to the whole-body RF coil 128 or to one or more local coils or coil arrays.

The RF system 120 also includes one or more RF receiver channels. An RF receiver channel includes an RF preamplifier that amplifies the magnetic resonance signal received by the coil 128 to which it is connected, and a detector that detects and digitizes the I and Q quadrature components of the received magnetic resonance signal. The magnitude of the received magnetic resonance signal may, therefore, be determined at a sampled point by the square root of the sum of the squares of the I and Q components:

$$M = \sqrt{{I}^{2} + {Q}^{2}} \qquad ( 1 )$$

and the phase of the received magnetic resonance signal may also be determined according to the following relationship:

$$φ = {tan}^{- 1} ( \frac{Q}{I} ) \qquad ( 2 )$$

The pulse sequence server 110 may receive patient data from a physiological acquisition controller 130. By way of example, the physiological acquisition controller 130 may receive signals from a number of different sensors connected to the patient, including electrocardiograph (“ECG”) signals from electrodes, or respiratory signals from a respiratory bellows or other respiratory monitoring devices. These signals may be used by the pulse sequence server 110 to synchronize, or “gate,” the performance of the scan with the subject's heart beat or respiration.

The pulse sequence server 110 may also connect to a scan room interface circuit 132 that receives signals from various sensors associated with the condition of the patient and the magnet system. Through the scan room interface circuit 132, a patient positioning system 134 can receive commands to move the patient to desired positions during the scan.

The digitized magnetic resonance signal samples produced by the RF system 120 are received by the data acquisition server 112. The data acquisition server 112 operates in response to instructions downloaded from the operator workstation 102 to receive the real-time magnetic resonance data and provide buffer storage, so that data is not lost by data overrun. In some scans, the data acquisition server 112 passes the acquired magnetic resonance data to the data processor server 114. In scans that require information derived from acquired magnetic resonance data to control the further performance of the scan, the data acquisition server 112 may be programmed to produce such information and convey it to the pulse sequence server 110. For example, during pre-scans, magnetic resonance data may be acquired and used to calibrate the pulse sequence performed by the pulse sequence server 110. As another example, navigator signals may be acquired and used to adjust the operating parameters of the RF system 120 or the gradient system 118, or to control the view order in which k-space is sampled. In still another example, the data acquisition server 112 may also process magnetic resonance signals used to detect the arrival of a contrast agent in a magnetic resonance angiography (“MRA”) scan. For example, the data acquisition server 112 may acquire magnetic resonance data and processes it in real-time to produce information that is used to control the scan.

The data processing server 114 receives magnetic resonance data from the data acquisition server 112 and processes the magnetic resonance data in accordance with instructions provided by the operator workstation 102. Such processing may include, for example, reconstructing two-dimensional or three-dimensional images by performing a Fourier transformation of raw k-space data, performing other image reconstruction algorithms (e.g., iterative or back-projection reconstruction algorithms), applying filters to raw k-space data or to reconstructed images, generating functional magnetic resonance images, or calculating motion or flow images.

Images reconstructed by the data processing server 114 are conveyed back to the operator workstation 102 for storage. Real-time images may be stored in a data base memory cache, from which they may be output to operator display 104 or a display 136. Batch mode images or selected real time images may be stored in a host database on disc storage 138. When such images have been reconstructed and transferred to storage, the data processing server 114 may notify the data store server 116 on the operator workstation 102. The operator workstation 102 may be used by an operator to archive the images, produce films, or send the images via a network to other facilities.

The MRI system 100 may also include one or more networked workstations 142. For example, a networked workstation 142 may include a display 144, one or more input devices 146 (e.g., a keyboard, a mouse), and a processor 148. The networked workstation 142 may be located within the same facility as the operator workstation 102, or in a different facility, such as a different healthcare institution or clinic.

The networked workstation 142 may gain remote access to the data processing server 114 or data store server 116 via the communication system 140. Accordingly, multiple networked workstations 142 may have access to the data processing server 114 and the data store server 116. In this manner, magnetic resonance data, reconstructed images, or other data may be exchanged between the data processing server 114 or the data store server 116 and the networked workstations 142, such that the data or images may be remotely processed by a networked workstation 142.

The present disclosure describes systems and methods for utilizing neural networks to segment adipose tissue, such as visceral adipose tissue (VAT) and subcutaneous adipose tissue (SAT), automatically, accurately, and rapidly on MR images. In some embodiments, an adipose tissue segmentation neural network can be configured to use multi-contrast MR images (e.g., multi-echo gradient echo images, proton-density fat fraction maps) as an input and produce segmentation maps for the desired adipose tissues, such as SAT and VAT, as outputs. It can be advantageous to use multiple types of contrasts, for example, T₁-weighted (TIW) images and fat and water images, as input to exploit the multi-contrast information from MRI. Furthermore, the disclosed systems and methods can consider the complex and disconnected nature of certain adipose tissues, such as VAT, by incorporating a frequency-balancing boundary-emphasizing Dice loss (FBDL) function during training of the adipose tissue segmentation neural network. Advantageously, the disclosed systems and methods can be used for a range of populations such as adults, children, and infants. In some embodiments, the disclosed adipose tissue segmentation neural networks may be based on convolutional neural networks, such as, for example, U-Nets, with certain modifications such as densely connected layers and attentional mechanism to enhance the segmentation performance. In some embodiments, the adipose tissue segmentation neural network may be implemented as a 2.5 dimensional (2.5D) or three-dimensional (3D) neural network. In some embodiments, a 2.5D network may be used when limited training data and computational resources are available. In some embodiments, a 3D network may be used when there are sufficient training samples and higher memory computational resources available. Accordingly, the selection of a 2.5D or 3D network can be based on the size of the training data available.

In some embodiments, the adipose tissue segmentation neural network can use a combined set of multi-contrast MR images (e.g., anatomical plus fat-water-separated images) as inputs, a large receptive field to exploit long-range feature associations across volumetric full field of view data, and/or shared information from a set of slices for the same subject. The outputs of the adipose tissue segmentation neural network can be segmentation maps of SAT, VAT, and other pixels (i.e., other tissue and background). In some embodiments, the adipose tissue segmentation neural network can be further trained and extended to, for example, segment SAT into two compartments, superficial and deep SAT, as well as to segment brown adipose tissue (BAT) and epicardial adipose tissue (EAT). In some embodiments, the segmentation generated by the disclosed adipose tissue segmentation neural network can help to characterize the risk for cardiometabolic disease such as diabetes, elevated glucose levels, and hypertension. In some embodiments, the disclosed adipose tissue segmentation neural network may be used as an automated tool to rapidly (e.g., <60) ms per slice) analyze body composition in adults with overweight/obesity.

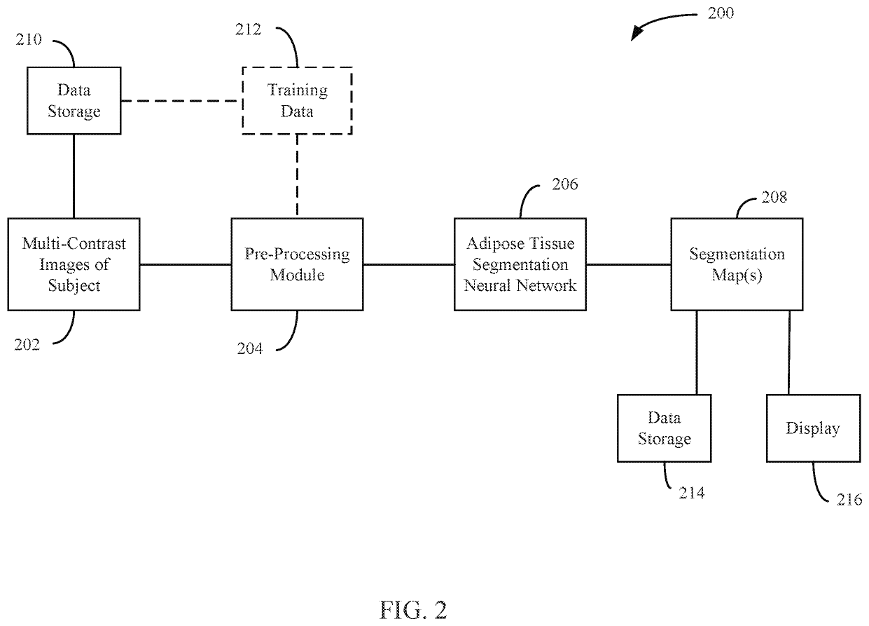

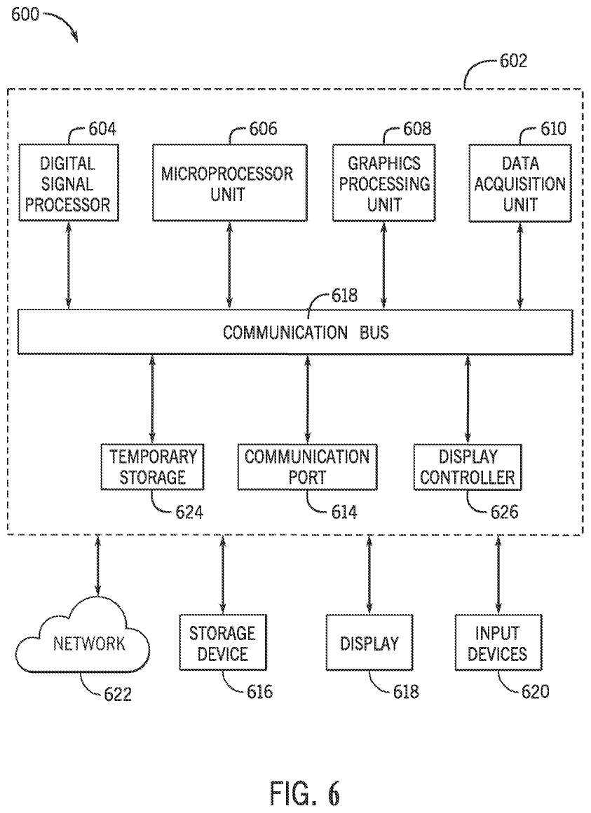

FIG. 2 is a block diagram of a system for segmenting adipose tissues in magnetic resonance (MR) images in accordance with an embodiment. System 200 can include an input of a plurality of multi-contrast images 202 of a subject, a pre-processing module 204, a trained adipose tissue segmentation neural network 206, an output 208 of the adipose tissue segmentation neural network (e.g., segmentation maps), data storage 210, 214, and a display 216. In some embodiments, the input multi-contrast images 202 of the subject may be MR images acquired using an MRI system such as, for example, MRI system 100 shown in FIG. 1. In some embodiments, the plurality of multi-contrast images 202 can include MR images of the subject with different types of contrast including. for example, T₁-weighted images (e.g., T₁-weighted gradient echo in-phase (TE_{IP}) and T₁-weighted gradient echo out-of-phase (TE_{OP}) images), water images, and/or fat images. The plurality of multi-contrast images can include various combinations of types of contrast images such as, for example, 1) water and fat images, 2) TE_{IP} and TE_{OP} images, 3) TE_{OP}, water, and fat images. In some embodiments, the input multi-contrast images 202 may also include proton-density fat fraction (PDFF) maps. The input multi-contrast images 202 may be acquired using known acquisition methods and techniques. For example, the multi-contrast images may be acquired using an axial T₁-weighted dual-echo Dixon MRI sequence. In some embodiments, the multi-contrast images 202 are full field of view (FOV) volumetric MR images. In some embodiments, the input multi-contrast images 202 may be retrieved from data storage (or memory) 210 of system 200, data storage of an imaging system (e.g., disc storage 138 of MRI system 100 shown in FIG. 1), or data storage of other computer systems (e.g., storage device 616 of computer system 600 shown in FIG. 6). In some embodiments, the input multi-contrast images 202 may be acquired in real time from a subject using an MRI system (e.g., MRI system 100 shown in FIG. 1). For example, MR data can be acquired from a subject using a pulse sequence performed on the MRI system and configured to acquire multi-contrast MR data. For example, in some embodiments, a dual-echo Dixon pulse sequence can be used to acquire MR data from a subject.

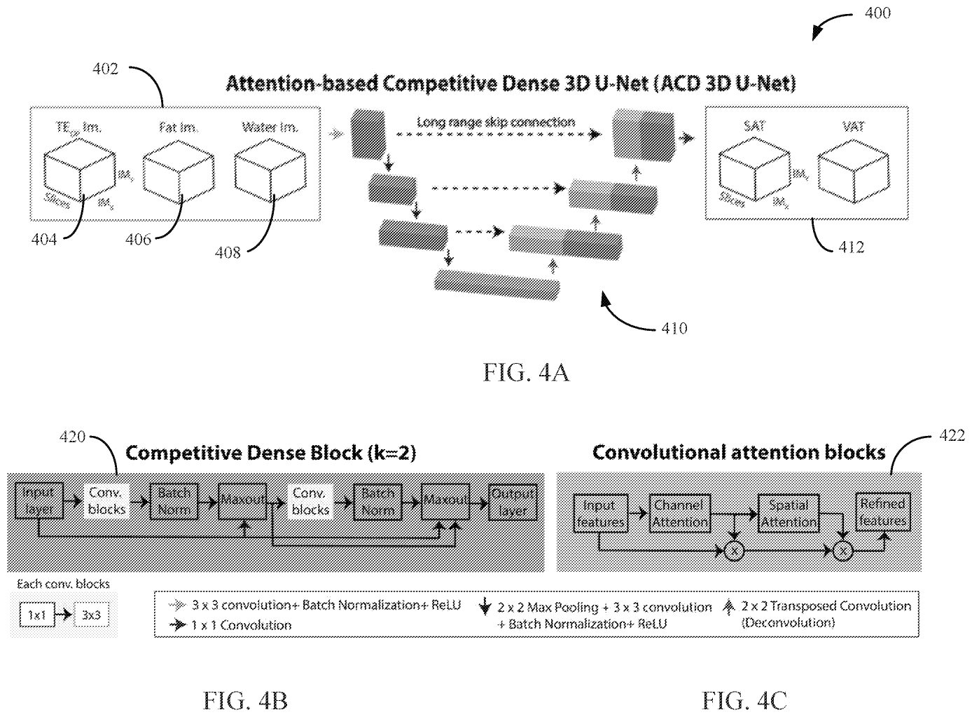

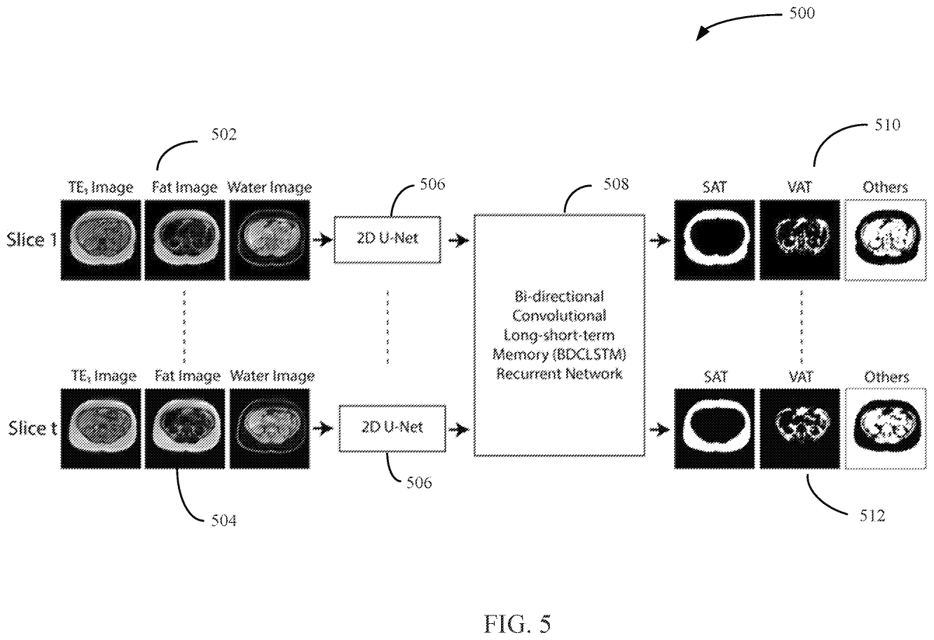

The multi-contrast images 202 may be provided as an input (e.g., via a multi-channel input) to the adipose tissue segmentation neural network 206. In some embodiments, the input multi-contrast images 202 may be pre-processed using the pre-processing module 204. For example, the pre-processing module 204 may be configured to perform pixel-intensity normalization. In some embodiments, the adipose tissue segmentation neural network 206 may be configured to generate segmentation maps of one or more adipose tissues including, for example, visceral adipose tissue (VAT), subcutaneous adipose tissue (SAT), superficial SAT, deep SAT, brown adipose tissue (BAT) and epicardial adipose tissue (EAT). In some embodiments, the adipose tissue segmentation neural network 206 can be a convolutional neural network for example, the adipose tissue neural network 206 may be implemented as a three-dimensional (3D) convolutional neural network (e.g., a 3D U-Net based architecture) or a 2.5-dimensional (2.5D) neural network (e.g., by expanding a 2D U-Net based architecture). In some embodiments, the adipose tissue segmentation neural network 206 may be implemented as an attention-based competitive (ACD) dense 3D U-Net. In some embodiments, the adipose tissue segmentation neural network 206 may be implemented as a 2.5D convolutional neural network with a bi-directional convolutional long-short term memory (BDCLSTM) in the through plane direction. Examples of 3D and 2.5D neural network architectures that may be used to implement the adipose tissue segmentation neural network 206 are discussed further below with respect to FIGS. 4A-4C and 5, respectively.

In some embodiments, the adipose tissue segmentation neural network 206 can be trained using training data (or dataset) 212. In some embodiments, the training data 212 includes multi-contrast MR images and reference segmentation maps for adipose tissue (e.g., SAT, VAT, etc.). In some embodiments, the training data may be manually annotated and confirmed by radiologists. The training data 212 may be acquired using known methods. In some embodiments, the adipose tissue segmentation neural network may be trained using known methods for training a neural network. In some embodiments, the training data 212 may be pre-processed using the pre-processing module 204. For example, pre-processing module 204 may be configured to perform pixel intensity normalization and data augmentation including techniques such as rotation, translation, noise injection, or deformable image registration. In some embodiments, a weighted Dice loss (WDL) function may be used for training the adipose tissue segmentation neural network 206. The standard weighted Dice loss (WDL) may be given by:

$$WDL = 1 - 2 \frac{{\sum }_{l = 1}^{3} {ω}_{l} {\sum }_{n} {r}_{ln} {p}_{ln}}{{\sum }_{l = 1}^{3} {ω}_{1} {\sum }_{n} {r}_{ln} + {p}_{ln}} \qquad ( 3 )$$

The weights in Equation 3 may be represented by ωₗ:

$${ω}_{1} = 1 / {( {\sum }_{n = 1}^{N} {r}_{ln} )}^{2} \qquad ( 4 )$$

Where, N: number of pixels; l: classes: rₗₙ and pₗₙ: reference and output segmented pixel n, respectively.

In some embodiments, the segmentation performance of VAT may be increased by using a more sophisticated loss function during training of the adipose tissue segmentation neural network 206, in particular, using a loss function that accounts for the complex spatially varying and disconnected nature of VAT. Accordingly, in some embodiments, a frequency-balancing boundary-emphasizing Dice loss (FBDL) function may advantageously be used for training the adipose tissue segmentation neural network 206. In the FBDL function, instead of using the standard weights, logistic weights may be set for ω₁, where the first term considers the SAT/VAT class (number of pixels) imbalance and second term emphasizes the boundaries (I: indicator function, f: class frequencies, ∇: gradient)

$${ω}_{0 = 2} \frac{median ( f )}{{f}_{min}}$$

gives higher priority to boundaries.

$${ω}_{l} = {\sum }_{n = 1}^{N} I ( {p}_{ln} == l ) \frac{median ( f )}{{f}_{1}} + {ω}_{0} I ( \vert ∇ {p}_{ln} \vert > 0 ) \qquad ( 5 )$$

Accordingly, the FBDL function may be given by:

$$FBDL = 1 - 2 \frac{{\sum }_{l = 1}^{3} {ω}_{l} {\sum }_{n} {r}_{ln} {p}_{ln}}{{\sum }_{l = 1}^{3} {ω}_{1} {\sum }_{n} {r}_{ln} + {p}_{ln}} \qquad ( 6 )$$

Where the class weights are defined by Equation 5.

The adipose tissue segmentation neural network 206 may be configured to generate an output 208 based on analysis of the input multi-contrast images 202 of the subject. The output 208 of the adipose tissue segmentation neural network may include one or more outputs such as, for example, one or more segmentation maps of one or more types of adipose tissue (e.g., SAT, VAT, BAT, EAT) and other pixels (e.g., other tissue and background). In some embodiments, the adipose tissue segmentation network may be configured to output 208 SAT and VAT segmentation maps concurrently. The output 208, e.g., segmentation maps of adipose tissue, may be displayed on a display 216 (e.g., display 618 of the computer system 600 shown in FIG. 6). The output 208 may also be stored in data storage, for example, data storage 214 (e.g., device storage 616 of computer system 600 shown in FIG. 6).

In some embodiments, the pre-processing module 204 and adipose tissue segmentation neural network 206 may be implemented on one or more processors (or processor devices) of a computer system such as, for example, any general-purpose computing system or device such as a personal computer, workstation, cellular phone, smartphone, laptop, tablet, or the like. As such, the computer system may include any suitable hardware and component designed or capable of carrying out a variety of processing and control tasks, including, but not limited to, steps for receiving multi-contrast images of the subject, implementing the pre-processing module 204, implementing the adipose tissue segmentation neural network 206, providing the output 208 (e.g. segmentation maps) of the adipose tissue segmentation neural network 206 to a display 216 or storing the output 208 in data storage 214. For example, the computer system may include a programmable processor or combination of programmable processors, such as central processing units (CPUs), graphics processing units (GPUs), and the like. In some implementations, the one or more processors of the computer system may be configured to execute instructions stored in a non-transitory computer readable-media. In this regard, the computer system may be any device or system designed to integrate a variety of software, hardware, capabilities, and functionalities. Alternatively, and by way of particular configurations and programming, the computer system may be a special-purpose system or device. For instance, such special purpose system or device may include one or more dedicated processing units or modules that may be configured (e.g., hardwired, or pre-programmed) to carry out steps, in accordance with aspects of the present disclosure.

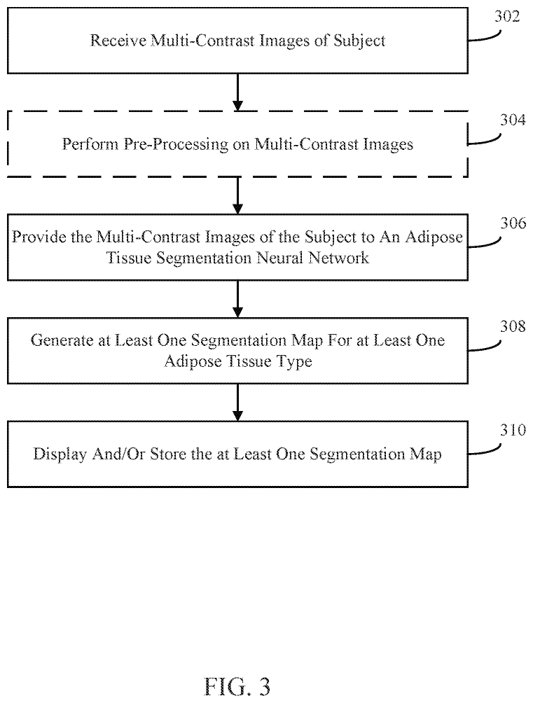

FIG. 3 illustrates a method for segmenting adipose tissues in magnetic resonance (MR) images. The process illustrated in FIG. 3 is described below as being carried out by the system 200 for segmenting adipose tissues in MR images as illustrated in FIG. 2. Although the blocks of the process are illustrated in a particular order, in some embodiments, one or more blocks may be executed in a different order than illustrated in FIG. 3, or may be bypassed.

At block 302, multi-contrast images 202 of a subject are received by the adipose tissue segmentation neural network 206. The multi-contrast images 202 of the subject may be MR images acquired using an MRI system such as, for example, MRI system 100 shown in FIG. 1. In some embodiments, the plurality of multi-contrast images 202 can include MR images of the subject with different types of contrast including, for example, T₁-weighted images (e.g., TE_{IP} and TE_{OP} images), water images, and fat images. The plurality of multi-contrast images can include various combinations of types of contrast images such as, for example, 1) water and fat images, 2) TE_{IP} and TE_{OP} images, 3) TE_{OP}, water, and Fat images. In some embodiments, the input multi-contrast images 202 may also include PDFF maps. The input multi-contrast images 202 may be acquired using known acquisition methods and techniques. For example, the multi-contrast images may be acquired using an axial T₁-weighted dual-echo Dixon MRI sequence. In some embodiments, the multi-contrast images 202 are full field of view (FOV) volumetric MR images. In some embodiments, the input multi-contrast images 202 may be retrieved from data storage (or memory) 210 of system 200, data storage of an imaging system (e.g., disc storage 138 of MRI system 100 shown in FIG. 1), or data storage of other computer systems (e.g., storage device 616 of computer system 600 shown in FIG. 6). As discussed above with respect to FIG. 2, in some embodiments, the multi-contrast images 202 may be acquired in real time from a subject using an MRI system (e.g., MRI system 100 shown in FIG. 1).

At block 304, in some embodiments, the input multi-contrast images 202 may optionally be pre-processed using the pre-processing module 204. For example, the pre-processing module 204 may be configured to perform pixel-intensity normalization. At block 306, the multi-contrast images 202 of the subject may be provided (input (e.g., via a multi-channel input) to an adipose tissue segmentation neural network 206. At block 308, at least one segmentation map 208 for at least one adipose tissue may be generated by the adipose tissue segmentation neural network 206. In some embodiments, the adipose tissue segmentation neural network 206 may be configured to generate segmentation maps of one or more adipose tissues including, for example, VAT, SAT, superficial SAT, deep SAT, BAT and epicardial adipose tissue EAT. In some embodiments, the adipose tissue segmentation neural network 206 can be a convolutional neural network, for example, the adipose tissue neural network 206 may be implemented as a three-dimensional (3D) convolutional neural network (e.g., a 3D U-Net based architecture) or a 2.5-dimensional (2.5D) neural network (e.g., by expanding a 2D U-Net based architecture). In some embodiments, the adipose tissue segmentation neural network 206 may be implemented as an attention-based competitive (ACD) dense 3D U-Net. In some embodiments, the adipose tissue segmentation neural network 206 may be implemented as a 2.5D convolutional neural network with a bi-directional convolutional long-short term memory (BDCLSTM) in the through plane direction. Examples of 3D and 2.5D neural network architectures that may be used to implement the adipose tissue segmentation neural network 206 are discussed further below with respect to FIGS. 4A-4C and 5, respectively.

At block 310, the generated segmentation maps 208 may be displayed on a display 216 (e.g., displays 104, 136, 144 of the MRI system 100 shown in FIG. 1 or display 618 of the computer system 600 shown in FIG. 6). The generated segmentation maps 208 may also be stored in data storage, for example, data storage 214 (e.g., disc storage 138 of the MRI system 100 shown in FIG. 1 or device storage 616 of computer system 600 shown in FIG. 6).

As mentioned above, the adipose tissue segmentation neural network 206 (shown in FIG. 1) may be implemented as a 3D convolutional neural network. In some embodiments. the adipose tissue segmentation neural network 206 may be based on 3D U-Net. The 3D U-Net can advantageously exploit global associations across the entire field-of-view (FOV). In some embodiments, the adipose tissue segmentation neural network 206 implemented as a 3D U-Net can utilize full field-of-view volumetric T₁-weighted, water, and fat images from, for example, dual-echo Dixon MRI, as a multi-channel input to automatically segment SAT and VAT for a subject, for example, in adults with overweight/obesity. In some embodiments, the 3D adipose tissue segmentation neural network 206 can be implemented with additional modifications to the 3D U-Net such as competitively and densely connected layers and attention mechanisms in channel and spatial dimension to emphasize the essential features and suppress the inconsequential ones as shown in FIGS. 4A-4C. Accordingly, in some embodiments, the adipose tissue segmentation neural network 206 may be implemented as an Attention-based Competitive Dense 3D U-Net (ACD 3D U-Net) trained with a class frequency-balancing Dice loss (FBDL) function.

FIG. 4A illustrates an example three-dimensional (3D) neural network for segmentation of adipose tissue in accordance with an embodiment. The 3D neural network 400 is implemented as an attention-based competitive dense (ACD) 3D U-Net network. The network 400 includes an input 402, an ACD 3D U-Net 410 and an output 414. The input 402 may be a plurality of multi-contrast images of a subject, for example, in FIG. 4A, the input 402 includes a TE_{OP} image 404, a fat image 406 and a water image 408. In some embodiments, the multi-contrast image input 402 may include the information from an entire set of n slices. Accordingly, the ACD 3D U-NET 410 may be subject-based (i.e., use the full volumetric MRI dataset as input). The ACD 3D U-Net 410 advantageously exploits global association across the entire field-of-view (FOV) for volumetric input images 402. In some embodiments, the ACD 3D U-Net architecture 410 can incorporate densely connected blocks 420 to improve the parameter flow and mitigate the vanishing gradients issue. FIG. 4B illustrates example densely connected convolutional blocks incorporated in the 3D neural network of FIG. 4A in accordance with an embodiment. In some embodiments, the competitive densely connected blocks 420 may have a growth rate of k=2. Competitive dense blocks are more computationally efficient than densely connected blocks. The ACD 3D U-Net architecture 410 may also include a channel and spatial attention mechanism (e.g., convolutional attention blocks 422) to, for example, exploit more important features and suppress the noisy features in spatial and channel dimensions. FIG. 4C illustrates an example attention mechanism incorporated in the 3D neural network of FIG. 4A in accordance with an embodiment. As discussed above, in some embodiments, the ACD 3D U-Net may advantageously be trained using a class-frequency-balancing, boundary-emphasizing Dice loss (FBDL) function, described above with respect to FIG. 2 and Equation 5. The ACD 3D U-Net may be configured to generate output segmentation maps 412 for SAT, VAT, and “other” pixels as described in more detail above with respect to FIGS. 2 and 3.

FIG. 5 illustrates an example 2.5-dimensional (2.5D) neural network for segmentation of adipose tissue in accordance with an embodiment. As mentioned above, the adipose tissue segmentation neural network 206 (show in FIG. 1) may be implemented as a 2.5D convolutional neural network. The 2.5D network 500 can consist of a 2D U-Net based convolutional neural network 506 and a bi-directional convolutional long-short term memory (BDCLSTM) recurrent network 508 in the through-plane dimension. The 2D U-Net 506 may be configured to process multi-contrast image inputs 502, 504 slice-by-slice. For example, a set of multi-contrast images (e.g., TE, fat, water) may be input and processed for each slice (1-t). The 2D U-Net 506 may then output these intermediate results to a BDCLSTM network 508 which may be configured to learn the through-slice associations, i.e., the shared information from t neighboring slices. The BDCLSTM network 508 may be configured to provide the t neighboring slices with respect to the central slice of interest. In some embodiments, the 2.5D network 500 can be more computationally efficient since it does not require 3D convolutions, training in three dimensions separately, and combining the resultant segmentations by an aggregation network. A benefit of utilizing a 2.5D network 500 may be the ability to learn the associations between neighboring slices without a large training dataset and high computational memory. The 2.5D network 500 may be configured to generate segmentation maps 510, 512 of adipose tissue (e.g., SAT, VAT) and other pixels (e.g., other tissue and background) for each slice.

FIG. 6 is a block diagram of an example computer system in accordance with an embodiment. Computer system 600 may be used to implement the systems and methods described herein. In some embodiments, the computer system 600 may be a workstation, a notebook computer, a tablet device, a mobile device, a multimedia device, a network server, a mainframe, one or more controllers, one or more microcontrollers, or any other general-purpose or application-specific computing device. The computer system 600 may operate autonomously or semi-autonomously, or may read executable software instructions from the memory or storage device 616 or a computer-readable medium (e.g., a hard drive, a CD-ROM, flash memory), or may receive instructions via the input device 620 from a user, or any other source logically connected to a computer or device, such as another networked computer or server. Thus, in some embodiments, the computer system 600 can also include any suitable device for reading computer-readable storage media.

Data, such as data acquired with, for example, an imaging system (e.g., a magnetic resonance imaging (MRI) system, etc.), may be provided to the computer system 600 from a data storage device 616, and these data are received in a processing unit 602. In some embodiments, the processing unit 602 included one or more processors. For example, the processing unit 602 may include one or more of a digital signal processor (DSP) 604, a microprocessor unit (MPU) 606, and a graphic processing unit (GPU) 608. The processing unit 602 also includes a data acquisition unit 610 that is configured to electronically receive data to be processed. The DSP 604, MPU 606, GPU 608, and data acquisition unit 610 are all coupled to a communication bus 612. The communication bus 612 may be, for example, a group of wires, or a hardware used for switching data between the peripherals or between any component in the processing unit 602.

The processing unit 602 may also include a communication port 614 in electronic communication with other devices, which may include a storage device 616, a display 618, and one or more input devices 620. Examples of an input device 620 include, but are not limited to, a keyboard, a mouse, and a touch screen through which a user can provide an input. The storage device 616 may be configured to store data, which may include data such as, for example, training data, multi-contrast images, segmentation data and maps, etc., whether these data are provided to, or processed by, the processing unit 602. The display 618 may be used to display images and other information, such as patient health data, and so on.

The processing unit 602 can also be in electronic communication with a network 622 to transmit and receive data and other information. The communication port 614 can also be coupled to the processing unit 602 through a switched central resource, for example the communication bus 612. The processing unit 602 can also include temporary storage 624 and a display controller 626. The temporary storage 624 is configured to store temporary information. For example, the temporary storage can be a random access memory.

Computer-executable instructions for segmenting adipose tissues in magnetic resonance (MR) images according to the above-described methods may be stored on a form of computer readable media. Computer readable media includes volatile and nonvolatile, removable, and non-removable media implemented in any method or technology for storage of information such as computer readable instructions, data structures, program modules or other data. Computer readable media includes, but is not limited to, random access memory (RAM), read-only memory (ROM), electrically erasable programmable ROM (EEPROM), flash memory or other memory technology, compact disk ROM (CD-ROM), digital volatile disks (DVD) or other optical storage, magnetic cassettes, magnetic tape, magnetic disk storage or other magnetic storage devices, or any other medium which can be used to store the desired instructions and which may be accessed by a system (e.g., a computer), including by internet or other computer network form of access.

The present invention has been described in terms of one or more preferred embodiments, and it should be appreciated that many equivalents, alternatives, variations, and modifications, aside from those expressly stated, are possible and within the scope of the invention.

1. A system for segmenting adipose tissues in magnetic resonance (MR) images, the system comprising:
a multi-channel input for receiving a set of combined multi-contrast MR images of a subject;
an adipose tissue segmentation neural network coupled to the input and configured to generate at least one segmentation map for an adipose tissue; and
a display coupled to the adipose tissue segmentation neural network and configured to display the at least one segmentation map for the adipose tissue.

2. The system according to claim 1, wherein the set of combined multi-contrast MR images includes anatomical, water, and fat images.

3. The system according to claim 2, wherein the anatomical images are T₁-weighted images.

4. The system according to claim 1, wherein the multi-contrast MR images are full field-of-view volumetric MR images.

5. The system according to claim 1, wherein the adipose tissue segmentation neural network is a 2.5D convolutional neural network comprises a bi-directional convolutional long-short term memory recurrent network in the through-plane dimension.

6. The system according to claim 5, wherein the 2.5D convolutional neural network further comprises a 2D U-Net convolutional network

7. The system according to claim 1, wherein the adipose tissue segmentation neural network is a 3D convolutional neural network comprising a plurality of densely connected convolutional blocks and a channel and spatial attention mechanism.

8. The system according to claim 7, wherein the 3D convolution neural network further comprises a 3D U-Net convolutional network.

9. The system according to claim 1, wherein the adipose tissue is one of a visceral adipose tissue and a subcutaneous adipose tissue.

10. The system according to claim 1, wherein the adipose tissue segmentation neural network is trained using a frequency-balancing boundary-emphasizing Dice Loss (FBDL) function.

11. The system according to claim 10, wherein the FBDL function is given by:
$$FBDL = 1 - 2 \frac{{\sum }_{l = 1}^{3} {ω}_{l} {\sum }_{n} {r}_{ln} {p}_{ln}}{{\sum }_{l = 1}^{3} {ω}_{1} {\sum }_{n} {r}_{ln} + {p}_{ln}}$$
where the class weights ωₗ are defined as
$${ω}_{l} = {\sum }_{n = 1}^{N} I ( {p}_{ln} == l ) \frac{median ( f )}{{f}_{1}} + {ω}_{0} I ( \vert ∇ {p}_{ln} \vert > 0 ) .$$

12. A method for segmenting adipose tissues in magnetic resonance (MR) images, the method comprising:
receiving a set of combined multi-contrast MR images of a subject;
providing the set of combined multi-contrast MR images to an adipose tissue segmentation neural network;
generating at least one segmentation map for an adipose tissue using the adipose tissue segmentation neural network;
displaying the at least one segmentation map on a display.

13. The method according to claim 12, wherein the adipose tissue segmentation neural network is trained using a frequency-balancing boundary-emphasizing Dice Loss (FBDL) function.

14. The method according to claim 13, wherein the FBDL function is given by:
$$FBDL = 1 - 2 \frac{{\sum }_{l = 1}^{3} {ω}_{l} {\sum }_{n} {r}_{ln} {p}_{ln}}{{\sum }_{l = 1}^{3} {ω}_{1} {\sum }_{n} {r}_{ln} + {p}_{ln}}$$
where the class weights ωₗ are defined as
$${ω}_{l} = {\sum }_{n = 1}^{N} I ( {p}_{ln} == l ) \frac{median ( f )}{{f}_{1}} + {ω}_{0} I ( \vert ∇ {p}_{ln} \vert > 0 ) .$$

15. The method according to claim 12, wherein the set of combined multi-contrast MR images includes anatomical, water, and fat images.

16. The method according to claim 15, wherein the anatomical images are T₁-weighted images.

17. The method according to claim 12, wherein the multi-contrast images are full field of view volumetric MR images.

18. The method according to claim 12, wherein the adipose tissue segmentation neural network is a 2.5D convolutional neural network comprising a bi-directional convolutional long-short term memory recurrent network in the through-plane dimension.

19. The method according to claim 12, wherein the adipose tissue segmentation neural network is a 3D convolutional neural network comprising a plurality of densely connected convolutional blocks and a channel and spatial attention mechanism.

20. The method according to claim 12, wherein the adipose tissue is one of a visceral adipose tissue and a subcutaneous adipose tissue.
